(19) United States
(12) Patent Application Publication
(10) Pub. No.: US 2002/0013542 A1
(43) Pub. Date: Jan. 31, 2002

(54) Exsanguinator

(76) Inventors: Frank Bonadio, Bray (IE); Ronan Bernard McManus, Bray (IE); Derek William Young, Blackrock (IE); Alan Reid, Clontarf (IE); Aoibheann Gill, Lanesboro (IE)

Correspondence Address: Finnegan, Henderson, Farabow, Garrett & Dunner, L.L.P., 1300 I Street, N.W., Washington, DC, 20005-3315, US

(21) Appl. No.: 09/867,403

(22) Filed: May 31, 2001

Related U.S. Application Data
(63) Continuation of application No. PCT/IE99/00125, filed on Dec. 1, 1999.

(30) Foreign Application Priority Data
Dec. 1, 1998 (IE) 980999
Dec. 1, 1998 (IE) 981000
Feb. 15, 1999 (IE) 990107
Feb. 15, 1999 (IE) 990108
Feb. 15, 1999 (IE) 990109
Feb. 15, 1999 (IE) 990110
Feb. 15, 1999 (IE) 990112
May 24, 1999 (IE) 990416

(51) Int. Cl. A61H 7/00

(52) U.S. Cl. 601/134

(57) ABSTRACT

An exsanguinator (1) for exsanguinating a limb such as an arm (2) comprises a substantially tubular sleeve (5) which is axially back on itself and twisted to define an outer sleeve section (11) and an inner twisted sleeve section (12). The inner sleeve section (12) defines a lumen (25) of reduced cross section which sealingly engages a limb. As the sleeve (5) is passed up along a limb it is inflated to an exsanguinating pressure. When the sleeve (5) has reached the top of the limb a tourniquer pressure is applied.

The present invention relates to an exsanguinator for exsanguinating limbs to create a bloodless field in advance of certain orthopaedic procedures and to maintain the area of interest ischaemic or blood-free during such procedures.

Certain orthopaedic procedures require a bloodless field of operation for the surgery to be performed easily. The presence of blood in the operative field can obscure the view of the surgeon and act as a hindrance to the speedy execution of the procedure. To overcome this problem a process of exsanguination is applied to the limb. To prevent blood from re-entering the limb a tourniquet is applied to the proximal part of the limb following exsanguination.

At present exsanguination is achieved by three commonly applied methods. In one case a limb is elevated for a short period and by gravity and blood empties from the limb. Removal of blood may be assisted by massaging the limb towards the heart or compressing it with the hands. This method is effective to remove venous blood from the limb but does not prevent arterial blood from re-entering the limb as the high pressures in arteries can overcome the effect of gravity. A pressure cuff or tourniquet may be applied at the top of the limb after a suitable period of time.

Another method is to apply elasticated bandages to the limb starting at the most distal part and working back towards the heart. The bandages are usually made of rubber and are one to three mm thick and approximately 10 centimetres wide. The bandage is applied by stretching it before each wrapping and overlapping the previous wrapping. When the top of the limb has been reached a pressure cuff or tourniquet may be applied to maintain ischaemia. This method is more effective than simple elevation of the limb, however it is time consuming and requires operator skill. In addition, this method cannot be used safely on fractured limbs due to the lateral forces applied in stretching the bandage.

US-A4228792 describes an exsanguinator comprising a double-walled tubular sleeve of elastomeric material. The tubular sleeve is rolled up the limb towards the heart. The pressure inside the device is such that it causes emptying of the venous system in the limb. A tourniquet or pressure cuff may be applied when the device has reached the top of the limb. This exsanguinator is however relatively difficult to operate and is relatively inefficient in exsanguinating a limb.

In all cases it is necessary to apply a tourniquet or pressure cuff to the limb to prevent blood from re-entering the limb. The pressure in these cuffs must be sufficiently high to occlude all arterial flow. It is often necessary to inflate these cuffs to a pressure greater than 300 mmHg in the case of arms and up to 500 mmHg in the case of legs. Significant damage to underlying structures such as nerves and blood vessels has been reported as a result of pressure cuffs. Underlying skin can be damaged due to the shear stress of the pressure cuff. To minimise these problems woollen bandages are often applied to the limb beneath the pressure cuff in an effort to reduce trauma to underlying structures.

When the limb has been made ischaemic a prepping solution is applied. This is a liquid normally containing chlorohexidrine, iodine or a similar bactericide that is painted onto the limb in advance of surgery. These liquids are known to cause severe chemical skin bums if they seep under the woollen bandages or are allowed to pool in an area already under shear stress from the pressure cuff.

There is a need for an exsanguinator which will overcome at least some of these problems.

### SUMMARY OF THE INVENTION

According to the invention there is provided an exsanguinator for exsanguination of a limb comprising:

a sleeve having an outer sleeve section and a twisted inner sleeve section;

a chamber for pressurised fluid defined between the inner and outer sleeve sections;

the twisted inner sleeve section defining a reduced lumen section to receive a limb; and

the sleeve being evertable so that as the sleeve is passed over a limb a twisted inner sleeve section is rolled over outwardly to become an outer sleeve section and an outer sleeve section is correspondingly rolled over inwardly to become a twisted inner sleeve section.

In a preferred embodiment the sleeve is turned axially back on itself to define the sleeve sections.

Preferably the sleeve is of pliable material.

In a preferred embodiment the outer sleeve section is a substantially cylindrical sleeve section and the inner sleeve section is a twisted sleeve section of the same untwisted diameter as that of the outer sleeve section.

Ideally the chamber is fluid impermeable.

Preferably the chamber is inflatable. In this case the chamber has a port for inflation of the chamber.

In a preferred embodiment of the invention the exsanguinator includes an anti-roll-off means.

The anti-roll-off means may be formed by a stocking over which the sleeve is rolled and retaining means for retaining the sleeve folded over the sleeve. Typically, the retaining means is a releasable fastening means.

In a preferred embodiment the exsanguinator includes a fluid barrier between a proximal end of a limb and the sleeve.

The fluid barrier preferably comprises a seal through which a limb is passed. The seal may be a lip-type seal.

In one embodiment the fluid barrier is mounted or mountable to a cover for the exsanguinator sleeve. Preferably the cover is open at a distal end for engaging over the exsanguinator sleeve.

Preferably the exsanguinator includes retaining means for fastening the cover to a limb. The retaining means is preferably a releasable fastening means.

In another aspect the invention provides a method for exsanguinating a limb comprising the steps of:

placing an evertable sleeve over a limb;

pressurising the evertable sleeve to an exsanguinating pressure;

everting the sleeve over the limb so that as the sleeve is passed over the limb an inner sleeve section is rolled over outwardly to become an outer sleeve section and an outer sleeve section is correspondingly rolled over inwardly to become an inner sleeve section; and

after exsanguinating the limb, applying a pressure to the sleeve to substantially prevent the flow of blood in the limb.

Preferably the sleeve is pressurised to about 50 to about 70 mm Hg for exsanguination of the limb. The exsanguination pressure may be approximately 60 mm Hg.

In a preferred embodiment the sleeve is pressurised to at least 250 mm Hg to substantially prevent the flow of blood in the limb.

In one embodiment the method includes the step of applying a fluid barrier between the sleeve and the limb.

Most preferably the method includes die step of fixing the sleeve in a desired position on a limb.

In a preferred method of the invention the exsanguinator is an exsanguinator of the invention.

### BRIEF DESCRIPTION OF THE DRAWINGS

The invention will be more clearly understood from the following description thereof given by way of example only in which:

FIG. 1 is a perspective view of an exsanguinator according to the invention;

FIG. 2 is a longitudinal cross sectional view of the exsanguinator of FIG. 1;

FIG. 3 is an end view of the exsanguinator;

FIG. 4 is a perspective view of the exsanguinator, in use;

FIG. 5 is another perspective view of the exsanguinator, in use;

FIG. 6 is a cross sectional view of the exsanguinator of FIG. 5 showing a patients limb;

FIG. 7(a) to 7(f) illustrate various steps in a method of exsanguinating a limb;

FIG. 8 is a perspective view of portion of another exsanguinator;

FIG. 9 is perspective view of an exsanguinator cover in use;

FIGS. 10 and 11 are views illustrating the cover of FIGS. 8 and 9 in use;

FIG. 12 is a perspective view of a tube from which the device may be formed;

FIG. 13 is a view of the tube of FIG. 12 partially folded over;

FIG. 14 is a view of the sleeve of FIG. 13 in a twisted configuration;

FIG. 15 is a side view of the twisted sleeve;

FIGS. 16 and 17 are respectively plan and elevational views of a non-twisted sleeve;

FIGS. 18 and 19 are respectively plan and elevational views of a twisted sleeve;

FIGS. 20 and 21 are respectively plan and elevational views of the twisted sleeve with an object extending through the lumen of the sleeve;

FIGS. 22 to 27 are views of the twisting of a tube similar to FIGS. 11 to 21;

FIGS. 28 and 29 are a graphical representation of the angle of twist plotted against lumen diameter.

FIG. 30 is a perspective view of a twisted tube with an elongate object passing therethrough;

FIG. 31 is an end view of the tube of FIG. 32;

FIGS. 33 to 38 are various plan and elevational views illustrating the formation and internal pressurising of a thin walled tube;

FIGS. 39 to 49 are various plan and elevational views illustrating the formation and internal pressurising of a thin walled twisted tube; and

FIGS. 50 to 55 are various side cross sectional and end views illustrating the translation of a elongate object through a twisted tube.

### DETAILED DESCRIPTION

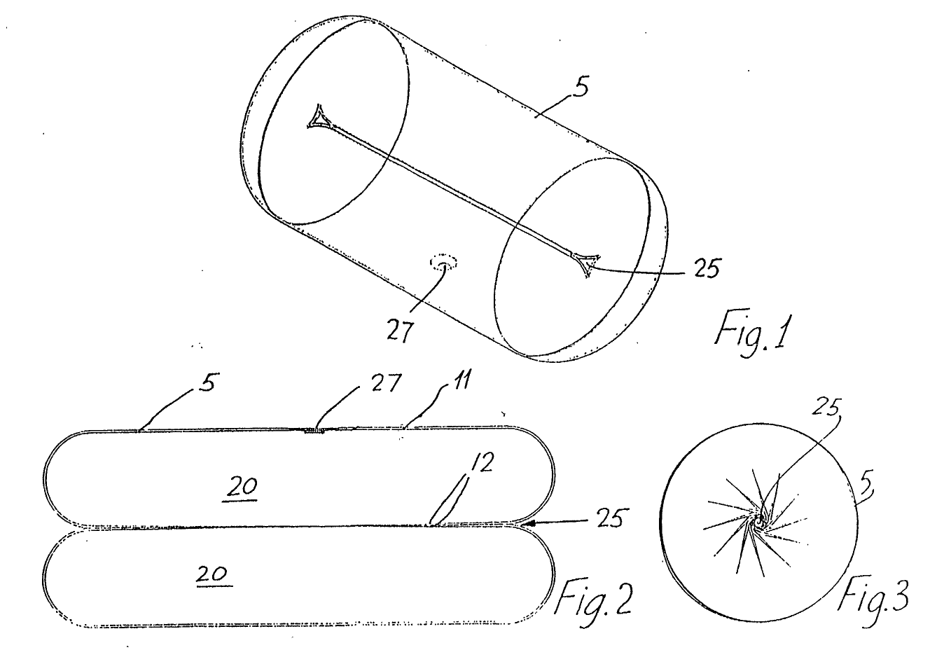

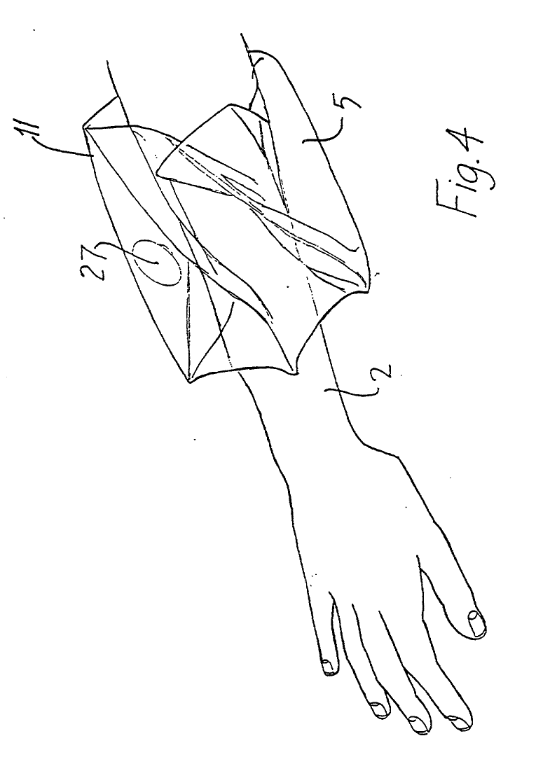

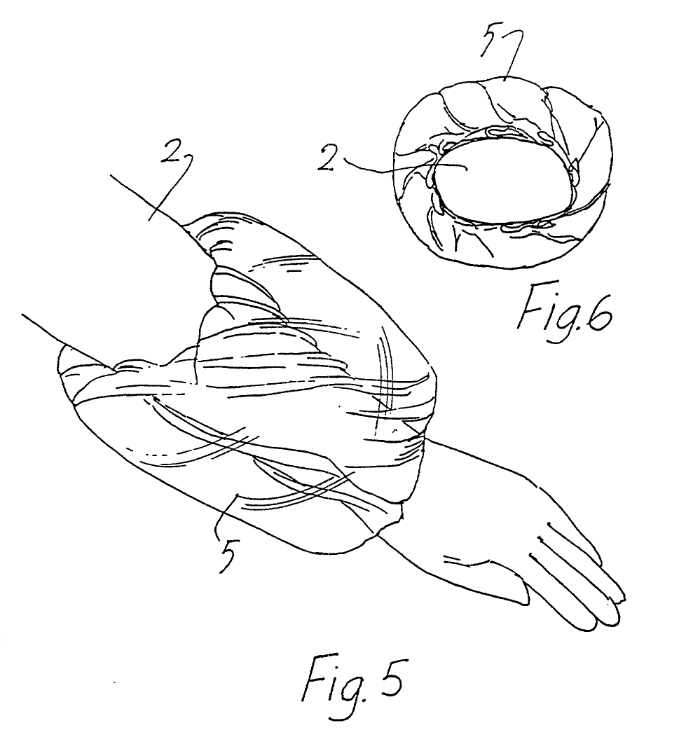

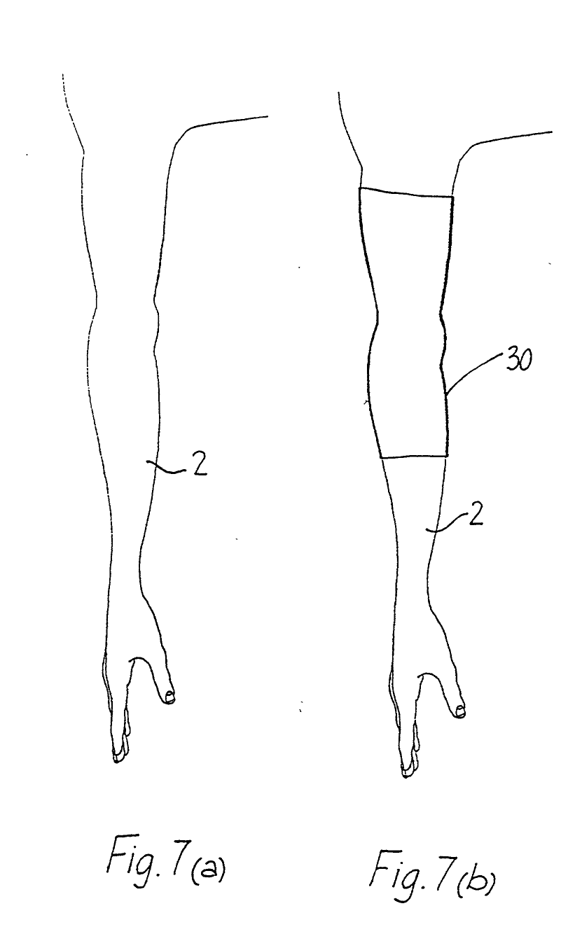

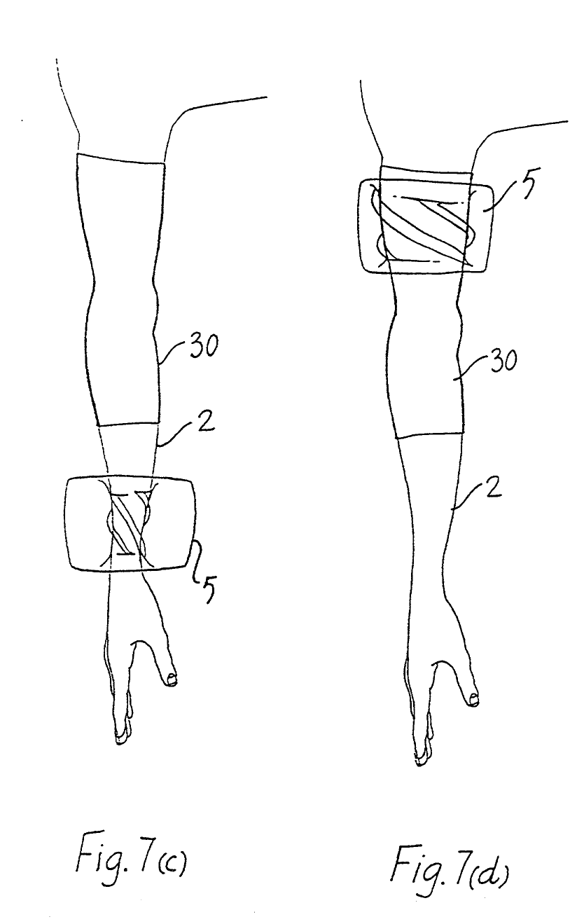

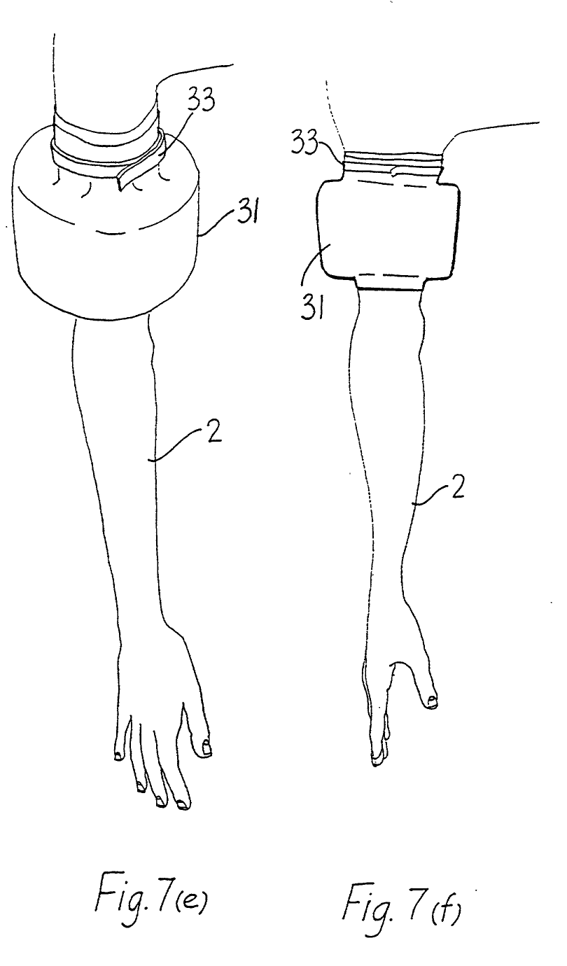

Referring to the drawings and initially to FIGS. 1 to 7 there is illustrated an exsanguinator 1 for use in a limb such as an arm 2.

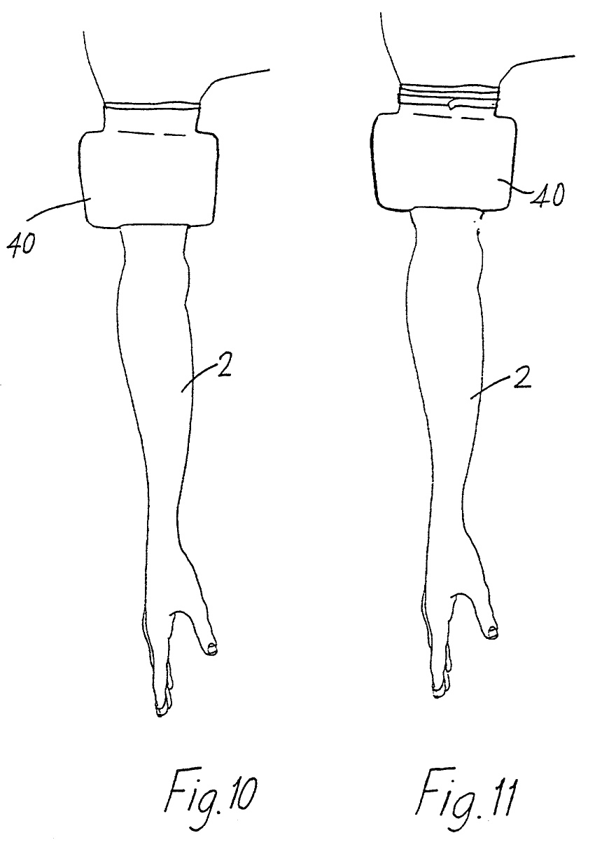

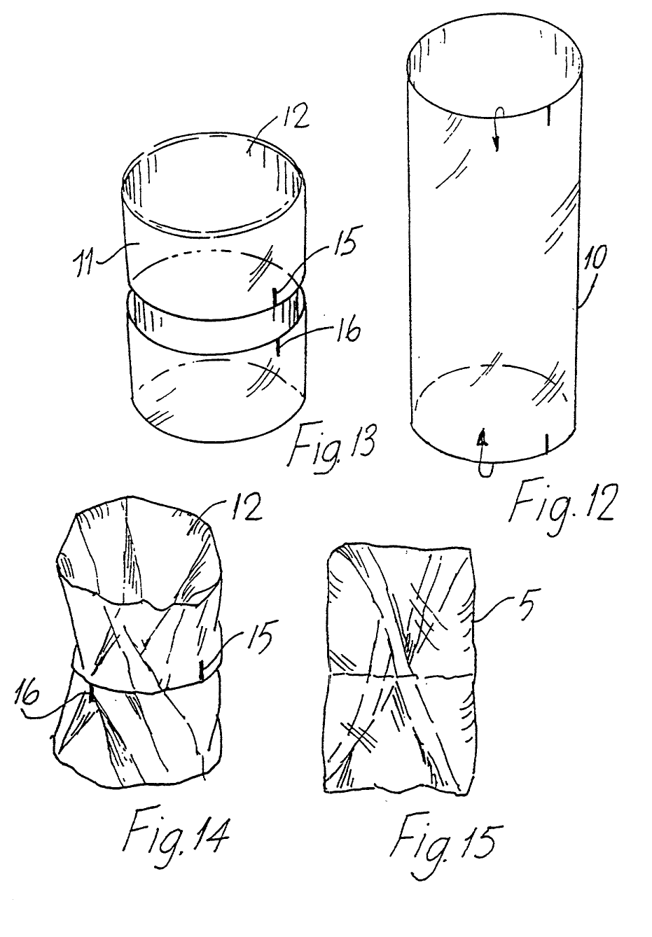

Referring in particular to FIGS. 12 to 15 the exsanguinator comprises a substantially tubular sleeve 5 of pliable gas tight material formed in from a tube 10 of a suitable biocompatible plastics material. The tube 10 is turned axially back on itself to define an outer sleeve section 11 and an inner sleeve section 12. The tube 10 is twisted so that the axially opposite datum indicators 15, 16 are circumferentially spaced-apart as illustrated in FIG. 14.

The inner and outer sleeve sections 11, 12 define therebetween a sealed inflatable chamber 20. The inner sleeve section 12, defines a lumen 25 and, on inflation of the chamber 20, the inner sleeve section 12 sealingly engages a limb 2 extending through the lumen 25.

The sleeve 5 includes a port 27 fitted with a valve for connection to a suitable inflation means.

In use, an anti-roll off means in the form of a stocking 30 is applied to the limb.

The device 1 is applied by first inflating to an exsanguinating pressure of about 50 to 70 mm Hg, typically approx. 60 mm Hg. The device is then rolled onto the limb 2 to be exsanguinated towards the heart. The device 1 is readily rolled up the limb 2 and as it is pressurised it creates a rolling pressure front, which is greater than mean systolic pressure in the limb 2, as it moves up the limb 2. This causes the displacement of venous blood from the limb 2 and prevents reperfusion through the arterial system. When the device has reached the top of the limb 2 causing it to be exsanguinated it is further inflated to achieve a tourniquet effect thus preventing the re-entry of blood into the limb 2.

The device can be attached to readily available pressure regulation equipment found in operating theatres. The simple construction method of the device allows it to be manufactured in a variety of sizes that can be selected for use with limbs of different size and thickness. In this manner the device will apply an appropriate amount of pressure, when it is in the tourniquet mode of operation, and so minimise the likelihood of causing damage to underlying structures. The device is easy to inflate and deploy onto the limb 2 to be exsanguinated.

When the exsanguinator sleeve 5 has exsanguinated the limb 5 an anti-roll off means and/or an eversion limiting means is applied to maintain the exsanguinator 1 in position. In this case the anti-roll off means is provided by part 31 of the stocking 30 which is folded back over the exsanguinator sleeve 5 and the free end of the stocking is retained in place using a suitable releasable fastening means such as strips 33 of releasable fabric available under the trade mark Velcro.

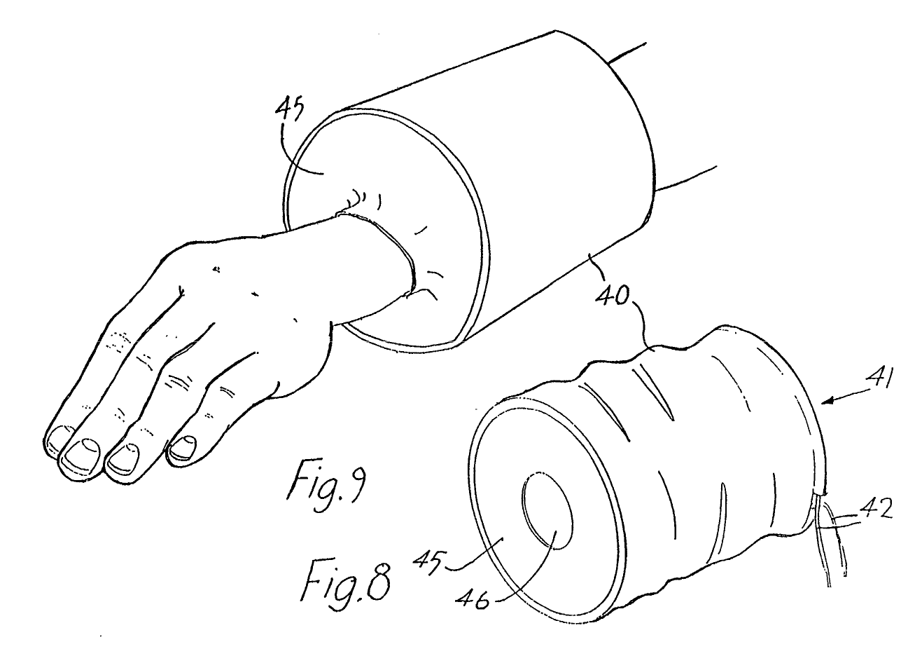

Referring to FIGS. 8 to 11 there is illustrated a cover 40 for the exsanguinator device 1. The cover 40 is open at one end 41 and a drawstring 42 or other suitable releasable fastening means is used to fix the cover in position on a limb 2. A fluid barrier in the form of a disc 45 of elastomeric material with a central limb-receiving lumen 46 is attached to the cover 40. The cover 40 is of elasticated, permeable or impermeable material with the drawstring 42 at one end and the polymeric or silastic lip-seal 45 at the other end. The hole 46 in the seal 45 is smaller than the diameter of the limb 2 around which it is to seal. The cover 40 is pulled up the limb 2 in the direction of venous flow after the exsanguinator 1 has been positioned and further inflated for its tourniquet effect. The drawstring end precedes the lip-seal end when pulling the cover 40 up the limb 2. The cover 40 is placed over the exsanguinator 1 and the drawstrings 42 pulled. The cover 42 prevents the exsanguinator 1 from rolling back down the limb 2. The lip-seal 45 prevents the passage of bactericidal limb preparation fluid underneath the exsanguinator.

The exsanguinator 1 may be used both as a means of exsanguinating a limb and as a means of maintaining the limb 2 ischaemic. The twisted sleeve provides an even distribution of pressure over and a limb 2 being exsanguinated. In addition, because the sleeve 5 is twisted it is more easily moved along a limb 2 than a non-twisted sleeve. The exsanguinator 1 includes means for protecting the skin under the device from damage caused by pooling of bactericidal liquid. The exsanguinator may be readily sterilised and therefore used following the sterilisation and prepping of the limb to be exsanguinated without contaminating the sterile field.

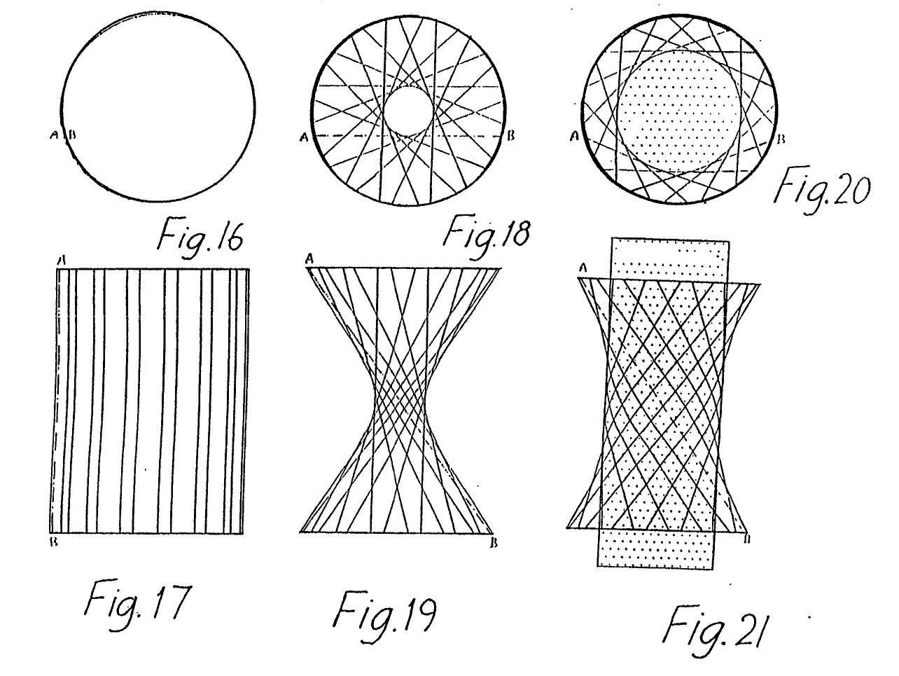

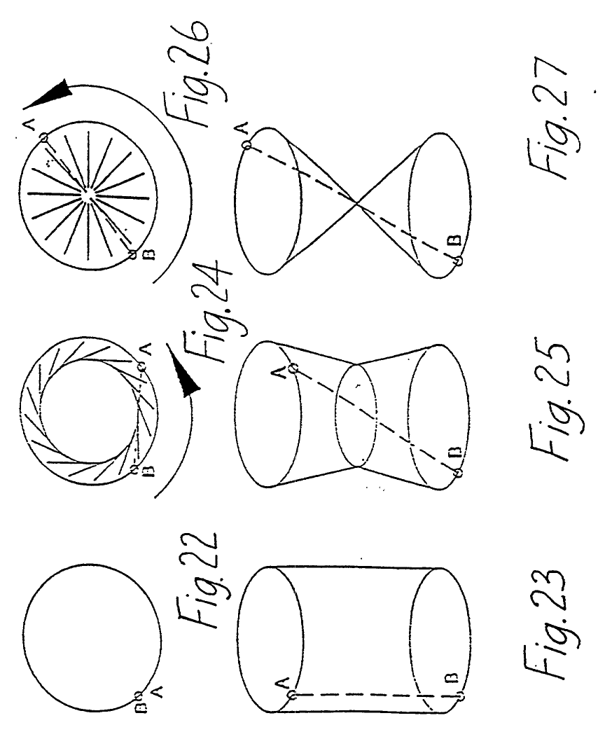

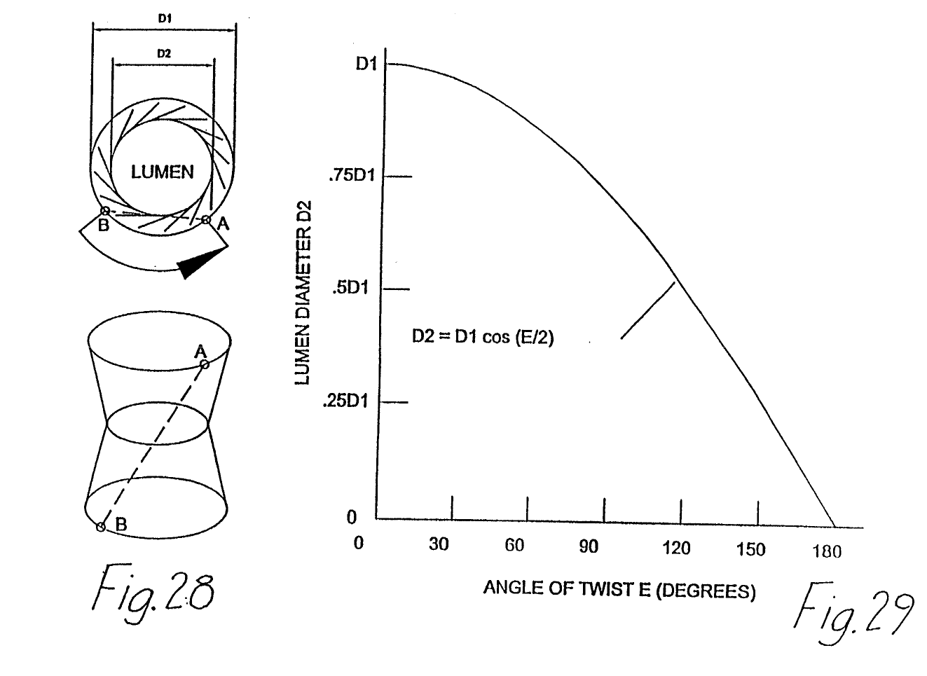

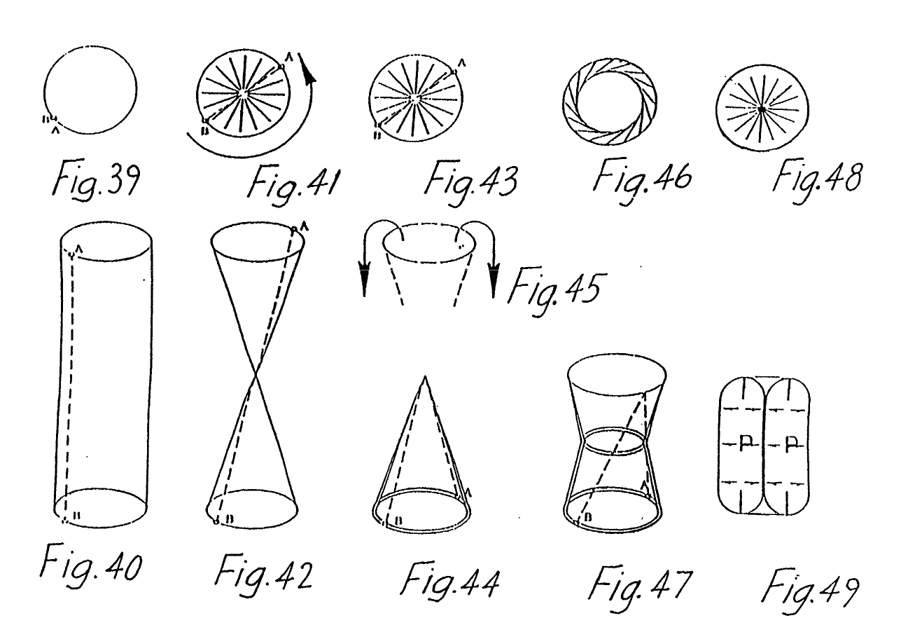

The principles which underlie this invention will be clearer from the following description with reference to FIGS. 16 to 55.

FIG. 16 depicts a thin walled tube of pliable material. It can be considered as a number of longitudinal elements, typical of which is the element A-B. Clearly there is a lumen passing through the tube, the diameter of which is the diameter of the tube. Rotation of one end of the tube relative to the other end about the axis of the tube causes the tube to twist into the configuration shown in FIG. 18.

The element A-B is now inclined to the axis of the tube but still remains a straight element. It is clear that element A-B in FIG. 18 appears longer than element A-B in 16 (it must have stretched). It follows therefore, that a force must be applied to the element to cause this elongation. In the absence of such a force elongation of the element A-B would not occur and the overall length of the tube would reduce (not depicted) in order to accommodate the change in geometry. At angles of twist less than 180° the element will not intersect the axis of the tube, its mid point being the point of closest proximity to the axis. It is the summation of all the elements at their midpoints that defines the minimum diameter of the reduced lumen formed. This diameter can be calculated knowing the original tube diameter and the angle of twist. The profile of the tube takes the form of a waisted, necked or hourglass shape. This profile is not determined by the shape of any individual element or elements but is the effect of a section in the plane of the tube axis taken through all the elements. Before proceeding to the effects of the introduction of an object into the reduced lumen particular notice should be taken the elements as they appear in the plan view FIG. 17. All the elements are straight.

Clearly, if an object of smaller diameter than the reduced lumen were introduced into the reduced lumen the object could pass through with out making contact with the wall of the reduced lumen. It would therefore not be possible for the tube to grip or create a seal to the object. In order to accommodate the introduction of an object of larger size (diameter) it is necessary that each element deform or bend outward thus forming an increased lumen. This can be seen clearly in FIG. 20. All the elements are now deformed. As before there is an apparent increase in the length of the elements. Also as before, in the absence of a force to elongate the elements the overall length of the tube will reduce to accommodate the change in geometry (not depicted). So it will be understood that the lumen has increased to accommodate the introduced object with out stretching the material of the tube and that the tube is intimate contact with the introduced object over at least part of its length.

The application of an axial force to the tube will cause the now deformed elements to try to straighten. Because the elements of the tube do not lie in the plane of the applied axial force there will be a corresponding radially inward force. This tendency toward straightening of the elements will be restricted by the presence of an object in the lumen. Therefore the radially inward component of the applied force will act on the inserted object creating a pressure or gripping force between the tube and the inserted object.

Referring to FIGS. 22 to 27 consider the hollow cylindrical tube shown in FIG. 23. The wall of the cylinder defines a lumen through its centre. Consider a linear element A-B. If the upper edge of the tube is rotated through some angle, point A will move to the position shown in FIGS. 24 and 25. The element A-B will still define a straight line. The tube will distort into a nominally hour glass shape with a reduced lumen at mid height. The diameter of the lumen at the neck of the tube is dependant on the angle of twist. When the upper edge is rotated through 180 the lumen will close down to zero diameter. At any horizontal plane through a twisted tube the material must be wrinkled and hence under compressive hoop stress. If the height of the tube remains unaltered then the element A-B in a twisted tube, being larger than in a plain tube, must be under tensile stress. If the tube is free of axial constraint the overall length of the tube will reduce.

Angle of Twist Vs. Lumen Diameter

FIG. 29 shows the lumen diameter (D2) as a proportion of the tube diameter (D1) for angles of twist (E) from 0° to 180°. The lumen diameter (D2) is calculated from:

D2=D1 cos(E/2).

As can be seen, the lumen diameter is independent of the tube length.

Elongate Object Passed through Twisted Tube

As can be seen from FIGS. 29, 30 and 31 the angle of twist necessary to collapse the lumen of a tube to the diameter of an elongate object passed therethrough is dependant on the ratio of the tube diameter to the diameter of the elongate object. The angle of twist can be calculated from:

E=2{ cos⁻¹(D2D1)}

where E is the angle of twist,

D1 is the tube diameter, and

D2 is the diameter of the elongate object.

Although depicted as of circular profile, a tube of sufficiently compliant material will conform to many non recursive profiles. For such a profile D2 is taken as the smallest diameter which can be inscribed within the profile.

Twin Walled Pressure Vessel under Internal Pressure

Referring to FIGS. 32 to 38 consider a thin walled tube as shown in FIG. 33. One end of the tube is folded back on itself as shown in FIG. 35 and the free ends conjoined. What is defined is essentially a twin walled tube (or two coaxial tubes conjoined at their ends) with an enclosed volume between the two walls. One way of extending the thin walled tube in an axial direction is to introduce a pressurised fluid into the enclosed volume. This causes the outer tube to be subject to tensile axial stress and tensile hoop stress. The inner tube will be subject to tensile axial stress and compressive hoop stress. As a result the diameter of the lumen reduces and the lumen collapses into a nominally duck bill configuration but constrained by the outer tube, FIG. 38.

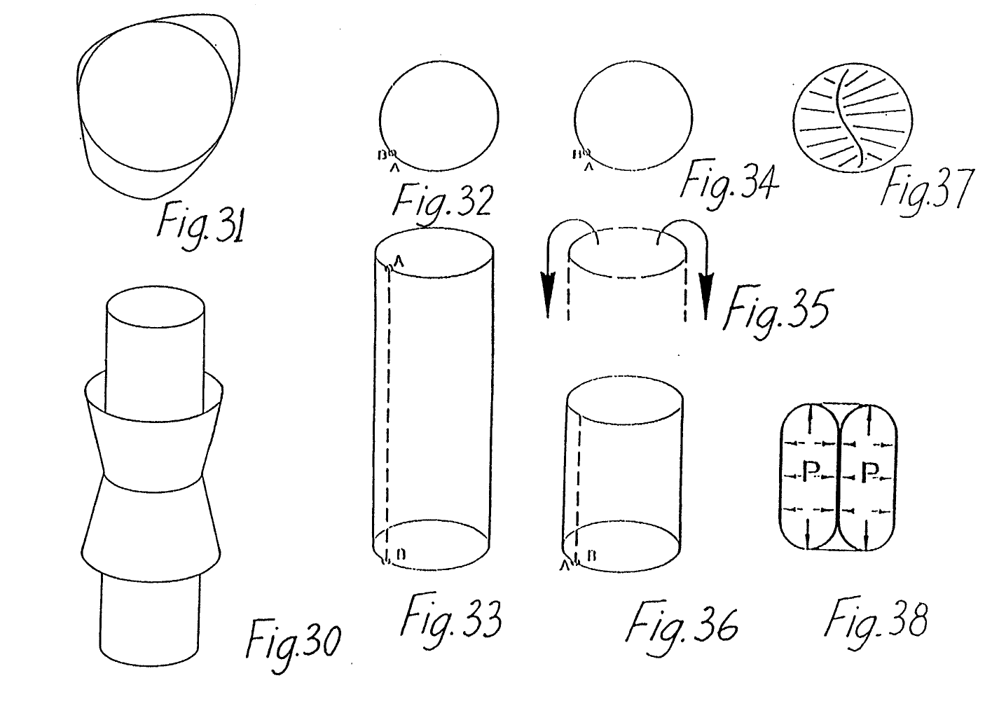

Greater control of the lumen can be obtained by the introduction of a twist into the tube. The tube shown in FIG. 40 is twisted as shown in FIG. 42. One end of the tube is folded back on itself, as shown in FIG. 44, and the free ends conjoined. This configuration defines two coaxial conical vessels conjoined at their bases and at a common apex. However the common apex is not constrained to remain in this configuration. In reality, the inner and outer tubes are free to behave as individual tubes each with half of the original twist and as such the composite tube can better be defined as two coaxial hour glass tubes as shown in FIG. 59, each containing half the original total twist. As both the inner and outer tubes are necked they each are subject to compressive hoop stresses.

Next a pressurised fluid is introduced into the enclosed volume. The introduction of the pressurised fluid extends the inner and outer tubes in an axial direction, reducing the lumen diameter. The outer tube is a necked hour glass tube with compressive hoop stresses. The introduction of the pressurised fluid also induces tensile hoop stresses, negating the compressive hoop stresses induced by the twist. Since, to remain in its twisted configuration, the tube must have compressive hoop stresses and since the pressurised fluid overcomes these compressive stresses the tube untwists and takes on a nominally cylindrical configuration, FIG. 39. Since the inner and outer tubes are conjoined, as the outer tube untwists the inner tube twists more in response. Since the outer tube now has no twist the inner tube must have all the twist. If the original total twist were 180° then the lumen would close totally. Additionally, the material defining the inner tube will be central within the diameter of the outer tube. This configuration will for brevity be called a Cyclops.

Translation of an Elongate Object through a Cyclops

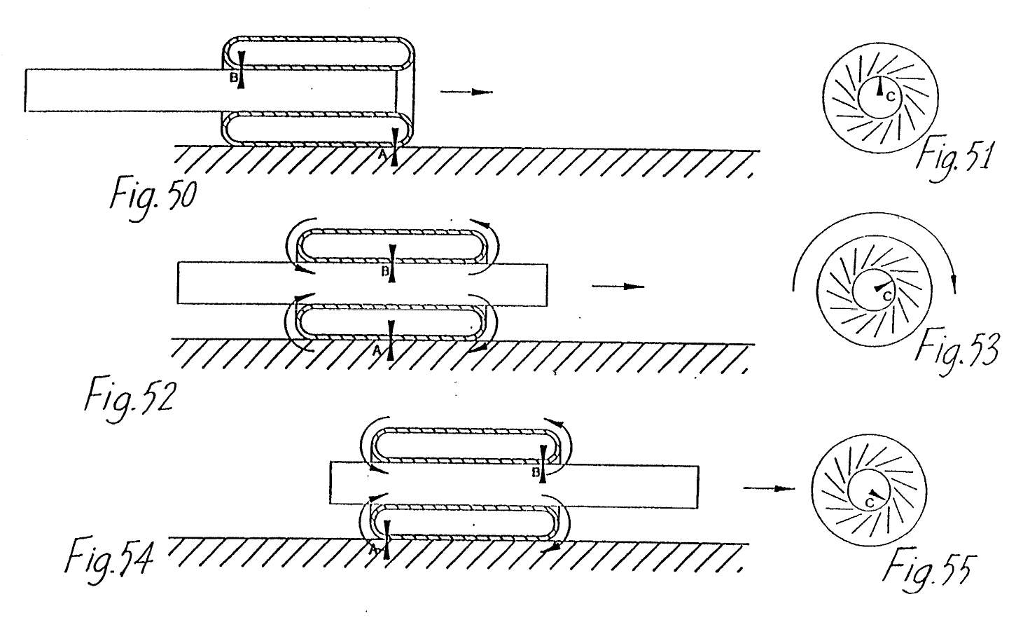

Consider the arrangement depicted in FIG. 50. A shaft is passed through a Cyclops with the lumen in mutual contact with the shaft. The outer tube of the Cyclops is resting in mutual contact with a fixed surface. Consider points of contact A, between the Cyclops and the fixed surface, and B, between the shaft and the lumen of the Cyclops. As the shaft is translated, as shown in FIG. 52, point A remains fixed whilst the leading end of the lumen rolls out. Since the Cyclops does not change in overall length the trailing end of the outer tube rolls in as depicted. It will be apparent that the shaft translates to the right twice as far as the Cyclops. This is exactly the motion of a caterpillar tract. From this point of view a Cyclops could be considered as a three dimensional caterpillar tract. Since points A and B on the Cyclops do not move relative to their corresponding positions on the shaft and the fixed surface there is no frictional resistance to the translation of the shaft. In FIG. 54, the Cyclops has translated to the right by approximately its own length. The material which had originally formed the inner tube has rolled out to become the outer tube and vice versa. In other words the Cyclops has turned inside out. Since the inner tube of the Cyclops is in a twisted configuration and since the point B remains in contact with the same point, the shaft rotates about it's axis as depicted by arrow C (in this instance approx. 120°). In order to obtain this, translation the resistance required to be overcome is that generated as the leading and trailing ends of the Cyclops deform as they roll out and roll in respectively.

Reference is also made to appropriate alternatives and modifications which are outlined in our parallel applications referenced ATRO1/C, ATRO12/C, ATRO14/C/, ATRO16/C/, ATRO17/C, the entire contents of which are incorporated herein by reference.

The invention is not limited to the embodiments hereinbefore described which may be varied in construction and detail.

1. An exsanguinator for exsanguination of a limb comprising:
a sleeve having an outer sleeve section and a twisted inner sleeve section;
a chamber for pressurised fluid defined between the inner and outer sleeve sections;
the twisted inner sleeve section defining a reduced lumen section to receive a limb; and
the sleeve being evertable so that as the sleeve is passed over a limb a twisted inner sleeve section is rolled over outwardly to become an outer sleeve section and an outer sleeve section is correspondingly rolled over inwardly to become a twisted inner sleeve section.

2. An exsanguinator as claimed in claim 1 wherein the sleeve is turned axially back on itself to define the sleeve sections.

3. An exsanguinator as claimed in claim 1 or 2 wherein the sleeve is of pliable material.

4. An exsanguinator as claimed in any preceding claim wherein the outer sleeve section is a substantially cylindrical sleeve section and the inner sleeve section is a twisted sleeve section of the same untwisted diameter as that of the outer sleeve section.

5. An exsanguinator as claimed in any preceding claim wherein the chamber is fluid impermeable.

6. An exsanguinator as claimed in any preceding claim wherein the chamber is inflatable.

7. An exsanguinator as claimed in any preceding claim wherein the chamber has a port for inflation of the chamber.

8. An exsanguinator as claimed in any preceding claim including an anti-roll-off means.

9. An exsanguinator as claimed in claim 8 wherein the anti-roll-off means is formed by a stocking over which the sleeve is rolled and retaining means for retaining the sleeve folded over the sleeve.

10. An exsanguinator as claimed in claim 9 wherein the retaining means is a releasable fastening means.

11. An exsanguinator as claimed in any preceding claim including a fluid barrier between a limb and the sleeve.

12. An exsanguinator as claimed in claim 11 wherein the fluid barrier comprises a seal through which a limb is passed.

13. An exsanguinator as claimed in claim 12 wherein the seal is a lip-type seal.

14. An exsanguinator as claimed in any of claims 11 to 13 wherein the fluid barrier is mounted or mountable to a cover for the exsanguinator sleeve.

15. An exsanguinator as claimed in claim 14 wherein the cover is open at a distal end for engaging over the exsanguinator sleeve.

16. An exsanguinator as claimed in claim 14 or 15 including retaining means for fastening the cover to a limb.

17. An exsanguinator as claimed in claim 16 wherein the retaining means is a releasable fastening means.

18. An exsanguinator substantially as hereinbefore described with reference to the accompanying drawings.

19. A method for exsanguinating a limb comprising the steps of:
placing an evertable sleeve over a limb;
pressurising the evertable sleeve to an exsanguinating pressure;
everting the sleeve over the limb so that as the sleeve is passed over the limb an inner sleeve section is rolled over outwardly to become an outer sleeve section and an outer sleeve section is correspondingly rolled over inwardly to become an inner sleeve section; and
after exsanguinating the limb, applying a pressure to the sleeve to substantially prevent the flow of blood in the limb.

20. A method as claimed in claim 19 wherein the sleeve is pressurised to about 50 to about 70 mm Hg for exsanguination of the limb.

21. A method as claimed in claim 20 wherein the exsanguination pressure is approximately 60 mm Hg.

22. A method as claimed in any of claims 19 to 21 wherein the sleeve is pressurised to at least 250 mm Hg to substantially prevent the flow of blood in the limb.

23. A method as claimed in any of claims 19 to 22 including the step of applying a fluid barrier between the sleeve and the limb.

24. A method as claimed in any of claims 19 to 23 including the step of fixing the sleeve in a desired position on a limb.

25. A method as claimed in any of claims 19 to 24 wherein the exsanguinator is an exsanguinator as claimed in any of claims 1 to 18.

26. A method for exsanguinating a limb substantially as hereinbefore described with a reference to the accompanying drawings.
